(19) United States
(12) Patent Application Publication
(10) Pub. No.: US 2026/0043119 A1
(43) Pub. Date: Feb. 12, 2026

(54) METHOD FOR COATING A RAZOR BLADE

(71) Applicant: BIC Violex Single Member S.A., Anoixi (GR)

(72) Inventors: Christos PANDIS, Anoixi (GR); Anastasios SIOZIOS, Anoixi (GR); Georgios TSIAKATOURAS, Anoixi (GR); Charisis ZOUMPOS, Anoixi (GR)

(73) Assignee: BIC Violex Single Member S.A., Anoixi (GR)

(21) Appl. No.: 19/279,473

(22) Filed: Jul. 24, 2025

(30) Foreign Application Priority Data
Aug. 8, 2024 (EP) 24193551.9

(51) Int. Cl. C23C 4/04; B26B 21/60; C23C 4/02; C23C 4/12

(52) U.S. Cl. CPC C23C 4/04; B26B 21/60; C23C 4/02; C23C 4/12

(57) ABSTRACT

A novel method for coating a razor blade with a polymer, the method including providing a polymer in a liquid so as to obtain a polymer dispersion; moving the polymer dispersion through an electrically conductive capillary nozzle; creating an electric field between the capillary nozzle and the razor blade; dispensing the polymer dispersion through the capillary nozzle while moving the nozzle relative to the razor blade along the razor blade edge; atomizing the polymer dispersion into droplets and moving the droplets within the electric field towards the razor blade edge; drying at least some of the droplets to particles including the polymer prior to contacting the surface of the razor blade edge; and heating the razor blade at a temperature above the melting point of the polymer particles to form a polymer coating.

### CROSS-REFERENCE TO RELATED APPLICATIONS

This patent application claims the benefit of priority under 35 U.S.C. § 119 to European Patent Application No. 24193551.9, filed on Aug. 8, 2024, the entirety of which is incorporated herein by reference.

### TECHNICAL FIELD

The present disclosure relates to novel razor blade coatings producing less material waste without compromising the performance. The present disclosure relates to methods of producing the same.

### BACKGROUND

Modern-day razor blades are coated on and close to their cutting edges with polymers for improving the shaving performance. In particular, edge coatings of polytetrafluoroethylene (PTFE) are used for their lubricating effect, reducing the friction between the razor and the skin, leading to a smoother perceived cutting experience and improved shaving comfort for the user.

Applying the aforementioned polymer coatings to the razor blade needs to be done in an industrially applicable way enabling high throughput at reproducible results. Industrial processes typically rely on spray coating methods such as disclosed in WO 2011/047727 A1. WO 2011/047727 A1 discloses a coating system comprising a spray gun being connected to a tank containing an aqueous colloidal PTFE nanodispersion with a particle concentration below 2 wt %. Multiple gas streams are utilized to nebulize the aqueous dispersion and transport the generated mist to the razor blade. The mist is deposited on the blade and the blade is heated to evaporate the water from the blade's surface. The blade is then transferred to a sinter station in order to unify and sinter the particles to a continuous polymer film.

Inherent to these methods, the resulting coatings tend to cover a much larger area and tend to have a much higher thickness than necessary for achieving the desired (lubricating) effects. Therefore, even when optimally recycling the polymers wasted during the spraying process, these methods are still resulting in a relatively high degree of material waste which is deposited on the product itself. This is particularly problematic when the coatings comprise fluorinated polymers such as PTFE since these polymers must be considered as so-called Forever Chemicals due to their exuberant degradation times.

Therefore, there is a need to reduce the amount of waste material associated with coating the edges of razor blades.

### SUMMARY

In a first aspect, the present disclosure provides a method for coating a razor blade with a polymer, the razor blade terminating in an edge portion, wherein the edge portion has a continuously tapering geometry with two razor blade sides converging towards a razor blade edge; the method comprising the steps of:
a. providing a polymer in a liquid so as to obtain a polymer dispersion;
b. moving the polymer dispersion through an electrically conductive capillary nozzle;
c. creating an electric field between the capillary nozzle and the razor blade;
d. dispensing the polymer dispersion through the capillary nozzle while moving the nozzle relative to the razor blade along the razor blade edge;
e. atomizing the polymer dispersion into droplets and moving the droplets within the electric field towards the razor blade edge;
f. drying at least some of the droplets to particles comprising the polymer prior to contacting the surface of the razor blade edge; and
g. heating the razor blade at a temperature above the melting point of the polymer particles to form a polymer coating.

In some embodiments, the polymer dispersion comprises nanoparticles having a mean hydrodynamic diameter below 1000 nm, more specifically below 500 nm, and in particular below 200 nm, wherein the hydrodynamic diameter is measured by dynamic light scattering.

In some embodiments, the polymer concentration in the polymer dispersion is 5 wt.-% or greater and less than 50 wt.-%, more specifically between 5 and 35 wt.-%, and in particular between 10 and 30 wt.-%, based on the total weight of the polymer dispersion.

In some embodiments, the polymer has a melting point within the range of 100 to 500° C., more specifically in the range of 250 to 450° C., and in particular in the range of 300 to 400° C.

In some embodiments, the polymer is a fluorine-containing polymer, more specifically a polytetrafluoroethylene (PTFE) and in particular a polytetrafluoroethylene with a weight-average molecular weight of within the range of 2,000 g/mol to 120,000 g/mol, more specifically in the range of 10,000 g/mol to 80,000 g/mol, and in particular in the range of 20,000 g/mol to 60,000 g/mol.

In some embodiments, the liquid is a liquid having a boiling point at atmospheric pressure of below 200° C., more specifically below 150° C. and in particular below 120° C.; and/or the liquid is a polar solvent, more specifically water and/or an alcohol, and in particular water and/or an alcohol which is selected from methanol, ethanol and propanol.

In some embodiments, moving the nozzle relative to the razor blade along the razor blade edge involves moving the nozzle along the razor blade edge or moving the razor blade in a direction parallel to its razor blade edge over the nozzle.

In some embodiments, the dispensed polymer dispersion is atomized into droplets having a size in the range of 100 nm to 8 μm, more specifically in the range of 300 nm to 5 μm, and in particular in the range of 500 nm to 2 μm.

In some embodiments, the dispensed polymer dispersion is atomized into droplets by selecting and/or controlling one or more of: the electric field strength, the diameter of the capillary nozzle, the temperature of the dispersion, the ambient temperature, the ambient pressure and the surface tension of the polymer dispersion.

In some embodiments, the time of flight of the droplets prior to contacting the surface of the razor blade is adjusted to allow at least some of the droplets to dry prior to contacting the surface of the razor blade.

In some embodiments, the majority of the droplets, specifically at least about 60%, more specifically at least about 80%, and in particular at least about 90% of the droplets are dried to a solid state prior to contacting the surface of the razor blade.

In some embodiments, at least some of the droplets are dried to particles comprising the polymer prior to contacting the surface of the razor blade edge by selecting and/or controlling one or more of: the electric field strength, the temperature of the dispersion, the ambient temperature, the ambient pressure, the boiling point and/or vapor pressure of the liquid, the gas flow encountered by the droplets in their flight path, the distance between the electrically conductive nozzle and the razor blade, the rate of atomization into the droplets, the size of the atomized droplets, and the particle size and the concentration of the polymer in the polymer dispersion.

In some embodiments, the droplets are dried prior to contacting the surface of the razor blade to a residual liquid content which is low enough so that the dried droplet matter is not mobile and/or not coalescing after contacting the surface of the razor blade edge.

In some embodiments, the droplets are dried prior to contacting the surface of the razor blade to a residual liquid content of less than 30 wt.-%, more specifically less than 20 wt.-%, even more specifically less than 10 wt.-%, yet more specifically less than 5 wt.-%, and in particular within the range of 0 to 3 wt.-%.

In some embodiments, the method is performed in a spray chamber.

In some embodiments, the spray chamber is operated at ambient pressure or at a partial vacuum, more specifically to an absolute pressure below 500 mbar, and in particular at an absolute pressure value below 100 mbar; and in particular at ambient pressure.

In some embodiments, the spray chamber is operated at a temperature ranging from 0 to 300° C., specifically from 5 to 100° C., and in particular from 10 to 50° C.

In some embodiments, the polymer dispersion is dispensed from a capillary nozzle having a diameter below 1 mm, more specifically below 500 μm, and in particular below 100 μm.

In a second aspect, the present disclosure provides a system for coating a razor blade with a polymer, the razor blade terminating in an edge portion, wherein the edge portion has a continuously tapering geometry with two razor blade sides converging towards a razor blade edge, wherein the system comprises a spray chamber for coating the razor blade; a container for receiving a polymer dispersion comprising a polymer in a liquid; a heater for heating the razor blade; and a controller for operating the system; wherein the spray chamber is equipped with an electrically conductive capillary nozzle which is in fluid communication with the container for receiving the polymer dispersion, means for generating an electric field between capillary nozzle and the razor blade, and means for moving the capillary nozzle while moving the nozzle relative to the razor blade along the razor blade edge; wherein the controller is configured to execute steps b. to g. of any embodiment of the first aspect.

In a third aspect, the present disclosure provides a razor blade, the razor blade terminating in an edge portion, wherein the edge portion has a continuously tapering geometry with two razor blade sides converging towards a razor blade edge; wherein one or both razor blade sides are provided with a coating comprising a polymer, wherein said coating forms a continuous stripe along the edge of the razor blade and wherein the continuous stripe is less than 25 μm, more specifically less than 20 μm, and in particular less than 15 μm, in width.

In some embodiments, the polymer has a melting point within the range of 100 to 500° C., more specifically in the range of 250 to 450° C., and in particular in the range of 300 to 400° C.

In some embodiments, the polymer is present on the blade in an amount of 0.1 to 20 μg, more particular from 0.5 to 10 μg, and in particular from 1 to 4 μg.

In some embodiments, the polymer is a fluorine-containing polymer, more specifically a polytetrafluoroethylene (PTFE) and in particular a polytetrafluoroethylene with a weight-average molecular weight of within the range of 2,000 g/mol to 120,000 g/mol, more specifically in the range of 10,000 g/mol to 80,000 g/mol, and in particular in the range of 20,000 g/mol to 60,000 g/mol.

In some embodiments, the continuous stripe along the edge of the razor blade has a coating thickness within the range of 10 nm to 500 nm, more specifically 15 nm to 300 nm, and in particular 20 nm to 200 nm.

In some embodiments, the razor blade's edge portion has a cross-section having a substantially symmetrical tapering geometry terminating in the razor blade edge, wherein the cross-section has a central longitudinal axis originating from the razor blade edge, and the razor blade's edge portion has a thickness of between about 1.5 μm and about 2.4 μm measured at a distance of about 5 μm along the central longitudinal axis from the blade edge.

In some embodiments, the razor blade is for a hand-held razor.

In a fourth aspect, the present disclosure provides a razor blade preparable by the method disclosed above.

In a fifth aspect, the present disclosure provides a cartridge comprising a plurality of razor blades, wherein at least one of the razor blades is according to any of the embodiments according to the third aspect.

### BRIEF DESCRIPTION OF THE DRAWINGS

FIG. 1 is a schematic drawing of a razor blade's edge portion in cross-sectional view, wherein a first layer and second layer are provided on the blade's edge portion.

FIG. 2 shows an embodiment of the thin stripe that is obtainable with the method according to a first aspect of the present disclosure.

FIGS. 3 to 5 show the sintered PTFE coating obtained in Examples 1 to 3 (optical microscopy at 500× magnification).

FIG. 6 shows the sintered PTFE coating obtained in Comparative Example 1 (optical microscopy at 500× magnification).

### DETAILED DESCRIPTION

Hereinafter, a detailed description will be given of the present disclosure. The terms or words used in the description and the aspects of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

In a first aspect, the present disclosure provides a method for coating a razor blade with a polymer.

Suitable razor blades may be any conventional modern-day razor blade. In some embodiments, the razor blade may comprise, essentially consist or consist of a metal, in particular a stainless steel. Stainless steel razor blades may exhibit high strength, hardness and corrosion resistance. The razor blade may have undergone grinding to form an edge (interchangeably also called tip). More specifically, the razor blade is terminating in an edge portion, wherein the edge portion has a continuously tapering geometry with two razor blade sides converging towards a razor blade edge.

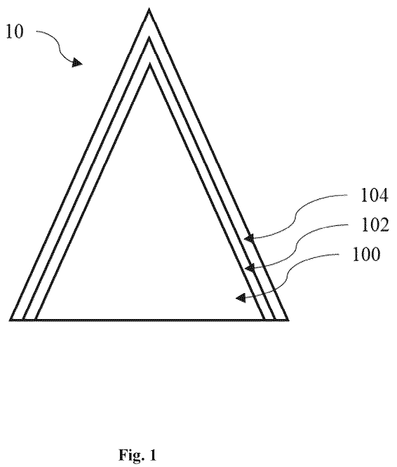

The coating method of the present disclosure allows to coat the razor blade with a polymer. More specifically, the razor blade edge (i.e. its cutting edge) is coated with the polymer. This does not necessarily mean that the polymer is directly coated on the edge of e.g. a stainless steel substrate of the razor blade. Rather, further layers may be optionally provided between the substrate and the polymer coating (as further detailed below). An embodiment of such a razor blade is shown in FIG. 1. FIG. 1 shows the cross-sectional view of the substrate edge portion 100 of a first exemplary razor blade 10. On the substrate edge portion 100, a first layer 102 comprising e.g. chromium is provided. A second layer 104 comprising the coating with the polymer according to the present disclosure is provided on the first layer 102. For the purposes of the present disclosure, the razor blade edge is represented by the substrate edge or, if further layers beneath the polymer coating layer are present, by the edge formed by these layers on the substrate edge.

The coating method of the present disclosure differs from the aforementioned industrial processes, such as disclosed in WO 2011/047727 A1, in that the method according to the present disclosure comprises a step of drying the atomized droplets prior to the droplets contacting the surface of the razor blade. The present inventors have surprisingly found that such a modified electrostatic spray coating method is able to provide a very narrow, defined and homogeneous polymer coating on and at the edge of the razor blade. Moreover, given the precise deposition, the method also allows to very precisely and reproducibly control the final deposited amount of polymer on the razor blade. Specifically, the method comprises the steps of:
a. providing a polymer in a liquid so as to obtain a polymer dispersion;
b. moving the polymer dispersion through an electrically conductive capillary nozzle;
c. creating an electric field between the capillary nozzle and the razor blade;
d. dispensing the polymer dispersion through the capillary nozzle while moving the nozzle relative to the razor blade along the razor blade edge;
e. atomizing the polymer dispersion into droplets and moving the droplets within the electric field towards the razor blade edge;
f. drying at least some of the droplets to particles comprising the polymer prior to contacting the surface of the razor blade edge; and
g. heating the razor blade at a temperature above the melting point of the polymer particles to form a polymer coating.

The drying step f. ensures that the particles remain largely immobile once hitting the razor blade surface. In contrast to liquid droplets, as generated by conventional electrospray coatings, the dried droplet matter has a reduced tendency to spread out on the surface of the razor blade in a surface wetting, to migrate on the surface, and to pool together into larger drops on the surface. This allows a very narrow, defined and homogeneous polymer coating on and at the edge of the razor blade.

In step a., the polymer provided in the polymer dispersion may be present in a solubilized form and/or suspended in a solution. In other words, throughout the present disclosure, the term polymer dispersion is meant to encompass both polymers which are dissolved in the liquid and polymers which are suspended as particles in the liquid.

In some embodiments, the polymer dispersion comprises particles of the polymer.

In some embodiments, the polymer dispersion comprises nanoparticles of the polymer.

In the present disclosure, the term nanoparticles is attributed its ordinary meaning in the art and is meant to refer to particles in the nanometer range, i.e. below 1 μm in size. In some embodiments, the nanoparticles of the polymer have a mean hydrodynamic diameter below 1000 nm, more specifically below 500 nm, and in particular below 200 nm, wherein the hydrodynamic diameter is measured by dynamic light scattering. Suitable devices for measuring the hydrodynamic diameter are well-known in the art and include e.g. the Litesizer DLS 100, obtainable from Anton Paar GmbH, Austria.

It has also been found that the homogeneity of the deposited coating may be further improved by increasing the concentration of the polymer (or particles) in the polymer dispersion and reduce the cutting force of the blade. Accordingly, in some embodiments, the concentration of the polymer in the polymer dispersion is greater than 5 wt.-%, more specifically equal to or greater than 10 wt.-%, and in particular between 10 and 30 wt.-%, based on the total weight of the polymer dispersion. From a viewpoint of process handling, it may be advantageous to not increase the concentration of the polymer (or particles) in the polymer dispersion to too high levels. Accordingly, in some embodiments, the polymer concentration in the polymer dispersion is less than 50 wt.-%, based on the total weight of the polymer dispersion. In some embodiments, it may be particularly advantageous that the concentration of the polymer (or dispersed particles) in the polymer dispersion is between 5.5 and 49.5 wt.-%, more specifically between 5.5 and 35 wt.-%, and in particular between 10 and 30 wt.-%, based on the total weight of the polymer dispersion.

In some embodiments, the polymer dispersion consists of the polymer particles, in particular nanoparticles and the liquid(s).

In some embodiments, the polymer has a melting point within the range of 100 to 500° C., more specifically in the range of 250 to 450° C., and in particular in the range of 300 to 400° C.

In some embodiments, the polymer is a fluorine-containing polymer. In some embodiments, the polymer is a lubricating polymer. In some embodiments, the polymer is a fluorinated polymer. In some embodiments, the polymer is a polytetrafluoroethylene (PTFE) and in particular a polytetrafluoroethylene with a weight-average molecular weight of within the range of 2,000 g/mol to 120,000 g/mol, more specifically in the range of 10,000 g/mol to 80,000 g/mol, and in particular in the range of 20,000 g/mol to 60,000 g/mol. Suitable devices are well-known in the art and include e.g. the Litesizer DLS 100, obtainable from Anton Paar GmbH, Austria, using standard ASTM D4001-20.

In some embodiments, the liquid is a liquid having a low boiling point and/or a low vapor pressure. The liquid can be a single liquid or a mixture of liquids. In some embodiments, the liquid comprises a liquid having a boiling point at atmospheric pressure of below 200° C., more specifically below 150° C. and in particular below 120° C. In some embodiments, the liquid is a polar solvent, more specifically water and/or an alcohol. In some embodiments, the liquid is water, an alcohol or a mixture of alcohols, or a mixture of water and alcohol(s). Suitable alcohols may be selected from methanol, ethanol and propanol.

In some embodiments, moving the nozzle relative to the razor blade along the razor blade edge involves moving the nozzle along the razor blade edge. The razor blade may be kept stationary, and the nozzle may be positioned above the edge and moved linearly along (i.e. parallel to) the edge. In some other embodiments, the razor blade is moved in a direction parallel to its razor blade edge over the nozzle.

The particulars of suitably adjusting the electrostatic spray coating process are well-known and not particularly limited. In some embodiments, dispensed polymer dispersion is atomized into droplets by selecting and/or controlling one or more of: the electric field strength, the diameter of the capillary nozzle, the temperature of the dispersion, the ambient temperature, the ambient pressure and the surface tension of the polymer dispersion.

As said, the electrostatic spray coating method is modified such that the atomized droplets dry prior to them contacting the surface of the razor blade. Again, the particulars of suitably adjusting the electrostatic spray coating process are not particularly limited. Suitable measures include selecting and/or controlling one or more of: the electric field strength, the temperature of the dispersion, the ambient temperature, the ambient pressure, the boiling point and/or vapor pressure of the liquid, the gas flow encountered by the droplets in their flight path, the distance between the electrically conductive nozzle and the razor blade, the rate of atomization into the droplets, the size of the atomized droplets, and the particle size (if the polymer is present in the form of particles) and the concentration of the polymer in the polymer dispersion. These measures can be used in isolation, but it is advantageous to use a combination of some or all of them.

The aforementioned measures may be selected and/or controlled to in particular adjust the evaporation rate of the liquid from the atomized droplets in relation to the time of flight of the droplets. The term time of flight refers to the time it takes for an atomized droplet to reach the razor blade after its generation. In some embodiments, the time of flight of the droplets prior to contacting the surface of the razor blade is adjusted to allow at least some of the droplets to dry prior to contacting the surface of the razor blade. This may in particular be realized by suitably adjusting the distance between the nozzle and the razor blade edge and the acceleration exerted by the electrostatic field. In some embodiments, the electrostatic field gradient is adjusted to be within the range of 0.50 to 3.50 kV/cm, more specifically 1.0 to 3.2 kV/cm, and in particular 2.0 to 3.0 kV/cm.

Moreover, the atomization of the polymer dispersion facilitates the drying by increasing the surface area of the droplets. The degree of droplet fission can i.a. be controlled by suitably adjusting the voltage of the electric field in combination with using a capillary nozzle. Generally speaking, the higher the voltage and the thinner the nozzle orifice, the better the atomization.

In some embodiments, the voltage of the electric field (ΔV) is in the range of about 10 to 100 kV, more specially between 15 and 60 kV, and in particular between 20 and 40 kV.

In some embodiments, the capillary nozzle has an (internal) diameter below 1 mm, more specifically below 500 μm, and in particular in the range of 100 μm to 400 μm. In some embodiments, the orifice of the capillary nozzle has a cross-sectional area of 0.0001 cm² to 0.0015 cm², more specifically 0.0002 cm² to 0.001 cm², and in particular 0.0003 cm² to 0.0008 cm².

In some embodiments, the dispensed polymer dispersion is atomized into droplets having a size in the range of 100 nm to 8 μm, more specifically in the range of 300 nm to 5 μm, and in particular in the range of 500 nm to 2 μm. The size of the droplets can be measured by any suitable method, for instance laser diffraction. The measurement of droplet sizes using laser diffraction involves passing the atomized droplets through a laser beam, resulting in light scattering (Fraunhofer diffraction or alternatively Mie diffraction) by the edges of the aerosolized droplets. The laser diffraction results are intrinsically volume-weighted. For the purposes of the present disclosure, it will be assumed that the atomized droplets are spherical, and the obtained volumes can be converted into particle sizes on that basis. A suitable standard that applies these principles is ISO 13320:2020.

When speaking of drying the droplets, it should be understood that it may not be necessary in all cases to completely evaporate the liquid prior to the particles contacting the surface of the razor blade. During their time of flight, the droplets lose liquid due to evaporation processes and it may in some cases be sufficient that the droplets reach a partially dried state in which solid particles are already present but are still coated with residual amounts of the liquid. In this state, these partially dried particles may behave as solid matter, i.e. similar to completely dried particles. In particular, such particles may remain largely immobile once hitting the razor blade surface, i.e. in contrast to liquid droplets generated by conventional spray coating and also conventional electrospray coating methods, the dried droplet matter has a reduced tendency to spread out on the surface of the razor blade in a surface wetting, to migrate on the surface, and to pool together into larger drops on the surface. In some embodiments, the droplets are dried prior to contacting the surface of the razor blade to a residual liquid content which is low enough so that the dried droplet matter is not mobile and/or not coalescing after contacting the surface of the razor blade edge. In some embodiments, the droplets are dried prior to contacting the surface of the razor blade to a residual liquid content of less than 30 wt.-%, more specifically less than 20 wt.-%, even more specifically less than 10 wt.-%, yet more specifically less than 5 wt.-%, and in particular within the range of 0 to 3 wt.-%. Moreover, it may in some cases not be necessary that all droplets are dried to the same degree since the coating process allows for some tolerance. Accordingly, in some embodiments, the majority of the droplets, specifically at least about 70%, more specifically at least about 80%, and in particular at least about 90% or all of the droplets are dried to a solid state prior to contacting the surface of the razor blade.

In some embodiments, the method is performed in a spray chamber. In some embodiments, the spray chamber is operated at ambient pressure or at a partial vacuum, more specifically at an absolute pressure below 500 mbar, and in particular at an absolute pressure value below 100 mbar; and in particular at ambient pressure. In some embodiments, the spray chamber is operated at a temperature ranging from 0 to 300° C., specifically from 5 to 100° C., and in particular from 10 to 50° C.

In some embodiments, the step of heating the razor blade at a temperature above the melting point of the polymer particles to form a polymer coating sinters the particles into the coating.

In some embodiments, the razor blades are further conveyed to a separate sintering station adapted to sinter the particles into the polymer coating. The sintering station may in particular be a linear heating oven allowing the sintering of the polymer. The sintering temperature is selected on basis of the polymer. In case of PTFE, PTFE typically melts at about 325° C., therefore the razor blades are heated in the heating oven to a temperature above 325° C., for instance to a temperature about 365° C. This sintering step may be performed under an inert gas atmosphere such as a nitrogen atmosphere in order to avoid any corrosion.

In a second aspect, the present disclosure relates to a system for coating a razor blade with a polymer, the razor blade terminating in an edge portion, wherein the edge portion has a continuously tapering geometry with two razor blade sides converging towards a razor blade edge, wherein the system comprises:
a spray chamber for coating the razor blade;
a container for receiving a polymer dispersion comprising a polymer in a liquid;
a heater for heating the razor blade; and
a controller for operating the system.

The spray chamber of the second aspect is equipped with an electrically conductive capillary nozzle which is in fluid communication with the container for receiving the polymer dispersion, means for generating an electric field between the capillary nozzle and the razor blade, and means for moving the capillary nozzle while moving the nozzle relative to the razor blade along the razor blade edge.

The controller of the second aspect is configured to execute steps b. to g. as disclosed above for the first aspect of the disclosure.

The specific embodiments disclosed for the first aspect of the disclosure are equally combinable with this second aspect of the disclosure.

As explained above, the electrostatic spray coating method of first aspect of the disclosure allows to provide a very narrow, defined and homogeneous polymer coating on and at the edge of the razor blade. Accordingly, in a third aspect, the present disclosure relates to a razor blade, the razor blade terminating in an edge portion, wherein the edge portion has a continuously tapering geometry with two razor blade sides converging towards a razor blade edge. One or both razor blade sides are provided with a coating comprising a polymer. The coating forms a continuous stripe along the edge of the razor blade. The continuous stripe is less than 25 μm, more specifically less than 20 μm, and in particular less than 15 μm, in width.

When referring to the width of the stripe, it should be understood that this refers to the extent of the continuous stripe in perpendicular direction away from the razor blade edge.

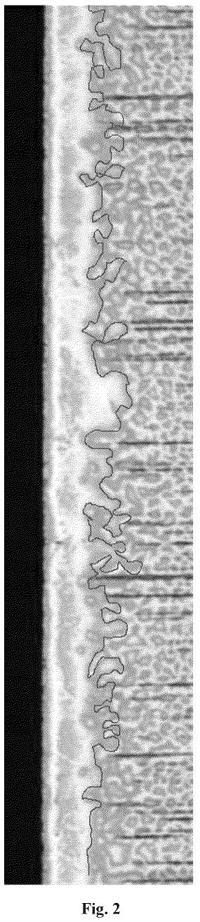

The extent of the continuous stripe extending away from the razor blade edge can be e.g. determined by the skilled person using e.g. optical or X-ray imaging of the respective side(s) of the razor blade's edge portion. An embodiment of the continuous stripe is shown in FIG. 2. As shown in FIG. 2, the polymer coating perfectly covers the blade edge in a thin stripe and the percentage of area covered by the coating rapidly decreases in the direction oriented perpendicularly away from the razor blade edge. Although there are localized irregularities (as to be expected in a spraying process), these irregularities average out when considering a longer distance or the entirety of the razor blade edge.

If more precision is required, a more systematic approach can additionally or alternatively be employed: FIG. 2 shows a red line which demarcates the terminal end of the coating continuously covering the blade edge and the adjacent razor blade side. A skilled operator can manually determine this line, optionally with the help of the appropriate visualization software. The width of the stripe can be determined by measuring (orthogonally to the blade's edge) the distance between the blade's edge and terminal red line at a representative number of intervals (e.g. every 5 μm) over a representative part of the edge portion (e.g. 500 μm) and numerically averaging the obtained values.

Additionally or alternatively, the thin stripe of polymer coating can also be characterized by the rapidly decreasing gradient of coverage of the blade's surface by the coating in the direction orthogonally away from the blade's edge. The gradient may be defined as the polymer coating covering more than 70 area-%, more specifically more than 80 area-%, and in particular more than 90 area-%, of the surface area between the razor blade edge and a first line which is parallel to the razor blade edge and distanced, measured in an orthogonal direction, 40 μm, more specifically 30 μm, and in particular 25 μm, from the razor blade edge.

Accordingly, in a related aspect, the present disclosure also relates to a razor blade, the razor blade terminating in an edge portion, wherein the edge portion has a continuously tapering geometry with two razor blade sides converging towards a razor blade edge, wherein a polymer coating covers more than 70 area-%, more specifically more than 80 area-%, and in particular more than 90 area-%, of the surface area between the razor blade edge and a first line which is parallel to the razor blade edge and distanced, measured in an orthogonal direction, 40 μm, more specifically 30 μm, and in particular 25 μm, from the razor blade edge. In some embodiments, said coating covers less than 70 area-%, more specifically less than 60 area-% and in particular less than 50 area-% of the area between the above first line and a second line which is parallel to the razor blade edge and distanced, measured in an orthogonal direction, 100 μm, more specifically 80 μm, and in particular 60 μm, from the razor blade edge.

In some embodiments, the polymer has a melting point within the range of 100 to 500° C., more specifically in the range of 250 to 450° C., and in particular in the range of 300 to 400° C.

In some embodiments, the polymer is a fluorine-containing polymer, more specifically a polytetrafluoroethylene (PTFE) and in particular a polytetrafluoroethylene with a weight-average molecular weight of within the range of 2,000 g/mol to 120,000 g/mol, more specifically in the range of 10,000 g/mol to 80,000 g/mol, and in particular in the range of 20,000 g/mol to 60,000 g/mol.

In some embodiments, the polymer is present on the blade in an amount of 0.1 to 20 μg, more particular from 0.5 to 10 μg, and in particular from 1 to 4 μg (per blade).

In some embodiments, the continuous stripe along the edge of the razor blade has a coating thickness within the range of 10 nm to 500 nm, more specifically 15 nm to 300 nm, and in particular 20 nm to 200 nm.

In some embodiments, the razor blade's edge portion has a cross-section having a substantially symmetrical tapering geometry terminating in the razor blade edge, wherein the cross-section has a central longitudinal axis originating from the razor blade edge, and wherein the razor blade's edge portion has a thickness of between about 1.5 μm and about 2.4 μm measured at a distance of about 5 μm along the central longitudinal axis from the blade edge.

Smaller blade edge portions may reduce the cutting force needed during the shaving action. Accordingly, in some embodiments, the cross-section of the blade's edge portion may have a substantially symmetrical tapering geometry terminating in a blade edge, the cross-section may have a central longitudinal axis originating from the blade edge, and the edge portion may have a thickness of between 1.5 μm and 2.4 μm measured at a distance of 5 μm along the central longitudinal axis from the blade edge. In some embodiments, the blade's edge portion has a thickness of between about 4.6 μm and about 6.8 μm, in particular about 4.62 to about 6.74 μm, measured at a distance of about 20 μm along the central longitudinal axis from the blade edge. In some embodiments, the blade's edge portion has a thickness of between about 10.3 μm and 14.4 μm, in particular about 10.32 to about 14.35 μm, measured at a distance of about 50 μm along the central longitudinal axis from the blade edge. In some embodiments, the blade's edge portion has a thickness of between about 19.8 μm and 27.6 μm, in particular about 19.82 to about 27.52 μm, measured at a distance of about 100 μm along the central longitudinal axis from the blade edge.

The above-described razor blades can be manufactured by any suitable means. More specifically, the preparation and grinding of the blade substrate can be performed by any suitable means, for instance as disclosed in US 2017/136641 A1 which is incorporated by reference in its entirety.

In some alternative embodiments, the razor blade's edge portion coated with a hard coating has a cross-section having a substantially symmetrical tapering geometry terminating in the razor blade edge, wherein the cross-section may have a central longitudinal axis originating from the blade edge, and the coated edge portion may have a thickness of between 1.57 μm and 2.45 μm measured at a distance of 5 μm along the central longitudinal axis from the blade edge. In some embodiments, the coated blade's edge portion has a thickness of between about 4.62 μm and about 6.84 μm, measured at a distance of about 20 μm along the central longitudinal axis from the blade edge. In some embodiments, the coated blade's edge portion has a thickness of between about 10.32 μm and 14.63 μm, measured at a distance of about 50 μm along the central longitudinal axis from the blade edge. In some embodiments, the coated blade's edge portion has a thickness of between about 19.82 μm and 27.62 μm, measured at a distance of about 100 μm along the central longitudinal axis from the blade edge When referring to the thickness of the edge portion coated with a hard coating, this should be understood as referring to the ultimate thickness including only the hard coating(s) and not any polymeric coating(s).

In some embodiments, the razor blade may be additionally provided with a hard coating. The hard coating may improve the razor blades hardness, in turn increasing the blade's durability, in particular its useful life. In some embodiments, the hard coating may comprise a ceramic, a metal and/or a non-metallic coating. In some embodiments, the ceramic may comprise a boride and/or a carbide and in particular titanium diboride. In some embodiments, the ceramic may comprise titanium, boron and carbon. In some embodiments, the metal of the hard coating may comprise chromium. In some embodiments, the non-metallic coating may comprise diamond-like-carbon.

When referring to a hard coating, it should be understood that the coating as such may be harder than the coated blade's edge portion and/or that the coated edge portion may be hardened in its entirety in comparison to the uncoated substrate edge portion. The hardness of the hard coating or coated edge portion may be determined by using a nanoindenter. During the nanoindentation process, a hard tip whose properties (mechanical properties, geometry, tip radius etc.) are known, penetrates the hard coating sample to be analyzed. For example, a Berkovich tip may be used for the indentation tests. The load enforced on the indenter tip was increased as the tip penetrated further into the specimen until penetration depth of 50-100 nm was reached. At this point, the load was held constant for a period of time and then the indenter was removed. The area of the residual indentation in the sample was measured. The hardness H is defined as the maximum load Pₘₐₓ divided by the residual indentation area A:

$$H = \frac{Pmax}{A}$$

In some embodiments, the hard coating or the edge portion may exhibit a hardness between about 5 GPa to about 30 GPa, more specifically between about 10 GPa to about 20 GPa.

In some embodiments, the hard coating comprises, essentially consists or consists of a metal, in particular chromium.

In some embodiments, the hard coating is provided beneath the polymer coating. In some embodiments, the hard coating is provided directly on the blade substrate. In some embodiments, the hard coating is provided on an adhesion-promoting intermediate layer which may be directly provided on the blade substrate. In some embodiments, the intermediate layer comprises titanium and/or niobium, more specifically titanium and in particular metallic titanium.

In some embodiments, the razor blade is for a hand-held razor.

In a related aspect, there is also provided a razor blade preparable by the method of any of the embodiments of the first aspect of the present disclosure.

In a fourth aspect, the present disclosure provides a cartridge comprising a plurality of razor blades according to any of the embodiments of the third aspect.

### Examples 1 to 3 and Comparative Example 1

The present disclosure will be further illustrated on the basis of following Examples 1 to 3 and Comparative Example 1. It should be understood that Examples 1 to 3 are only provided for illustrative purposes and that other examples are possible within the scope of the appended claims.

Stainless steel razor blades were coated with PTFE dispersions of DuPont DryFilm LW-2120 which is a dispersion of 20 wt.-% nanoparticulate PTFE of a Mw of 40,000 g/mol in water and which is designed specifically as a blade coating.

In Example 1, which relates to an electrostatic spray coating method according to the present disclosure, the electrostatic spraying was performed in an electrostatic spraying chamber which was equipped with a high-voltage power supply with respective electrodes attached to the nozzle and the conductive collector (i.e. the metallic stack of blades to be coated), a capillary nozzle and a syringe pump. To allow drying of the atomized droplets prior to them hitting the razor blade, the following process parameters were used:
Concentration of aqueous PTFE dispersion: DuPont DryFilm LW-2120, diluted to 15%
Deposition time: 10 min
Metallic nozzle having the needle size: 26 gauge (=260 μm internal diameter)
Flow: 0.3 μL/min
Distance of the nozzle orifice to blade edge: 10 cm
ΔV: 30 KV
Substrate and dispersion temperature: ambient temperature
Conditions in the spraying chamber: ambient conditions

The razor blade was linearly moved under the spraying nozzle. Sintering of the deposited PTFE was subsequently performed at about 350° C.

In Examples 2 and 3, the setup of Example 1 was modified in that the deposition time was increased to 20 min and 30 min, respectively.

In Comparative Example 1, a PTFE coating was performed using an industrial process. More specifically, the process disclosed in WO 2011/047727 A1 was used, using a razor blade coating system as described in this publication, using conditions optimized for a commercial setting. Sintering of the deposited and subsequently dried PTFE was performed at about 350° C.

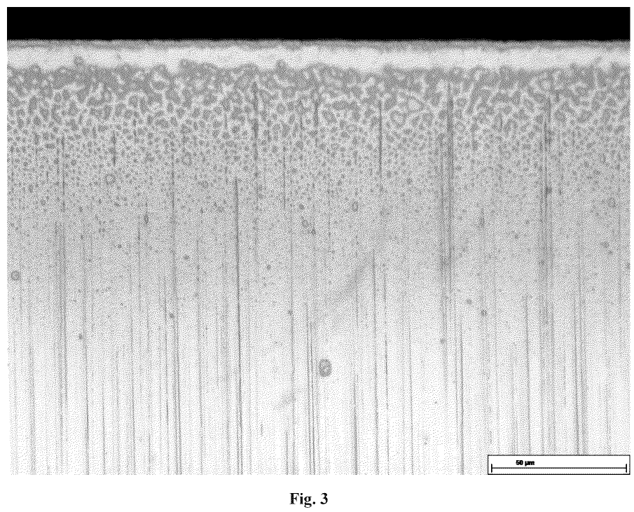

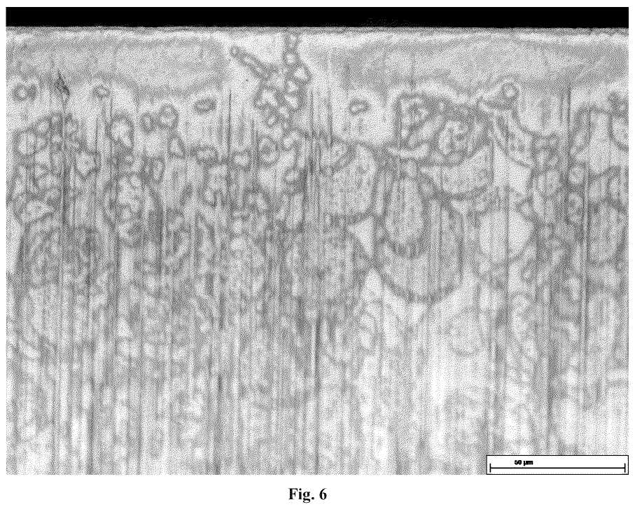

FIGS. 3 to 5 show the sintered coating obtained in Examples 1 to 3 (optical microscopy at 500× magnification). FIG. 6 shows the sintered coating obtained in Comparative Example 1 (optical microscopy at 500× magnification). All images are sized to the same size and the size bar in the right bottom corner of all images shows 50 μm.

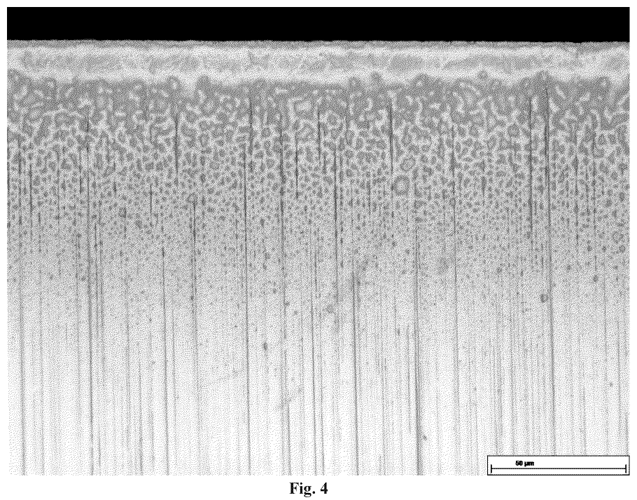

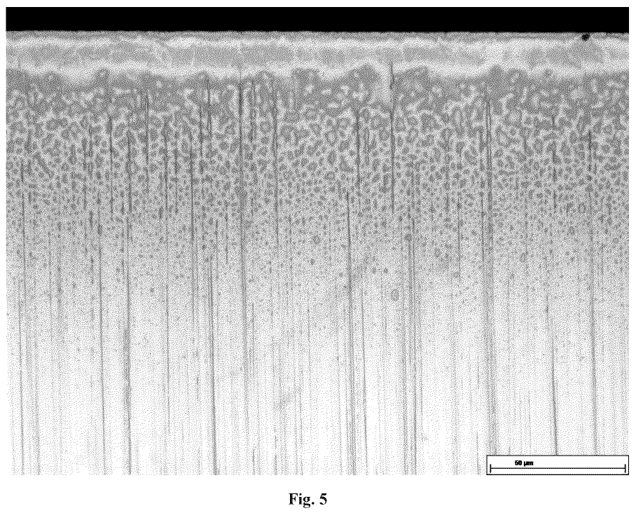

As evident from the comparison of FIGS. 3 to 5, the coatings of Examples 1 to 3 develop very uniformly and homogenously as a thin stripe on the blade's edge. Even after 10 minutes of deposition, a continuous and uniform stripe of PTFE coating has already formed on the blade's edge. The stripe has a width of about 5 μm. Increasing the deposition time increases the thickness of the coating (as apparent by the darker color) but does hardly increase the width of the PTFE coating stripe after 20 min of deposition (compare FIG. 4 and FIG. 5). Moreover, traces of the deposited coating extend for no more than about 80 μm away from the blade's edge.

In Comparative Example 1, the deposited PTFE coating is more inhomogeneous at the cutting edge in both coverage and coating thickness. Moreover, the coating has spread in an uncontrolled fashion over the blade with the large circular deposition patterns suggesting the coalescence of the deposited droplets prior to drying and sintering. As further seen in FIG. 6, the thicker parts of the coating at the blade's edge are located in a surface area between the razor blade edge and a first line which is parallel to the razor blade edge and distanced, measured in an orthogonal direction of about 40 μm, from the razor blade edge. Moreover, traces of the deposited coating extend for more than 150 μm away from the blade's edge.

Cutting tests were performed for the blades of Examples 1 to 3 and Comparative Example 1 and confirmed the above observation. The better uniformity and homogeneity of the thin coating stripe at the blade edges in Examples 1 to 3 resulted in a reduction of the cutting force of between 4 to 10% in comparison to Comparative Example 1. Long term performance (up to 10 cutting cycles) showed similar trends in wear for all samples, indicating that the coating of Examples 1 to 4 had similar durability as the coating of Comparative Example 1.

The present disclosure also relates to embodiments or combination of embodiments from the following list of embodiments.

1. A method for coating a razor blade with a polymer,
the razor blade terminating in an edge portion, wherein the edge portion has a continuously tapering geometry with two razor blade sides converging towards a razor blade edge;
the method comprising the steps of:
a. providing a polymer in a liquid so as to obtain a polymer dispersion;
b. moving the polymer dispersion through an electrically conductive capillary nozzle;
c. creating an electric field between the capillary nozzle and the razor blade;
d. dispensing the polymer dispersion through the capillary nozzle while moving the nozzle relative to the razor blade along the razor blade edge;
e. atomizing the polymer dispersion into droplets and moving the droplets within the electric field towards the razor blade edge;
f. drying at least some of the droplets to particles comprising the polymer prior to contacting the surface of the razor blade edge; and
g. heating the razor blade at a temperature above the melting point of the polymer particles to form a polymer coating.

2. The method of embodiment 1, wherein the polymer dispersion comprises nanoparticles having a mean hydrodynamic diameter below 1000 nm, more specifically below 500 nm, and in particular below 200 nm, wherein the hydrodynamic diameter is measured by dynamic light scattering.

3. The method of embodiment 1 or embodiment 2, wherein the polymer concentration in the polymer dispersion is 5 wt.-% or greater and less than 50 wt.-%, more specifically between 5 and 35 wt.-%, and in particular between 10 and 30 wt.-%, based on the total weight of the polymer dispersion.

4. The method of any preceding embodiment, wherein the polymer dispersion comprises or consists of the polymer nanoparticles and the liquid(s).

5. The method of any preceding embodiment, wherein the polymer has a melting point within the range of 100 to 500° C., more specifically in the range of 250 to 450° C., and in particular in the range of 300 to 400° C.

6. The method of any preceding embodiment, wherein the polymer is a fluorine-containing polymer, more specifically a polytetrafluoroethylene (PTFE) and in particular a polytetrafluoroethylene with a weight-average molecular weight of within the range of 2,000 g/mol to 120,000 g/mol, more specifically in the range of 10,000 g/mol to 80,000 g/mol, and in particular in the range of 20,000 g/mol to 60,000 g/mol.

7. The method of any preceding embodiment, wherein the liquid is a liquid having a boiling point at atmospheric pressure of below 200° C., more specifically below 150° C. and in particular below 120° C.; and/or wherein the liquid is a polar solvent, more specifically water and/or an alcohol, and in particular water and/or an alcohol which is selected from methanol, ethanol and propanol.

8. The method of any preceding embodiment, wherein moving the nozzle relative to the razor blade along the razor blade edge involves moving the nozzle along the razor blade edge or moving the razor blade in a direction parallel to its razor blade edge over the nozzle.

9. The method of any preceding embodiment, wherein the dispensed polymer dispersion is atomized into droplets having a size in the range of 100 nm to 8 μm, more specifically in the range of 300 nm to 5 μm, and in particular in the range of 500 nm to 2 μm.

10. The method of any preceding embodiment, wherein the dispensed polymer dispersion is atomized into droplets by selecting and/or controlling one or more of: the electric field strength, the diameter of the capillary nozzle, the temperature of the dispersion, the ambient temperature, the ambient pressure and the surface tension of the polymer dispersion.

11. The method of any preceding embodiment, wherein the time of flight of the droplets prior to contacting the surface of the razor blade is adjusted to allow at least some of the droplets to dry prior to contacting the surface of the razor blade.

12. The method of any preceding embodiment, wherein the majority of the droplets, specifically at least about 60%, more specifically at least about 80%, and in particular at least about 90% of the droplets are dried to a solid state prior to contacting the surface of the razor blade.

13. The method of any preceding embodiment, wherein at least some of the droplets are dried to particles comprising the polymer prior to contacting the surface of the razor blade edge by selecting and/or controlling one or more of: the electric field strength, the temperature of the dispersion, the ambient temperature, the ambient pressure, the boiling point and/or vapor pressure of the liquid, the gas flow encountered by the droplets in their flight path, the distance between the electrically conductive nozzle and the razor blade, the rate of atomization into the droplets, the size of the atomized droplets, and the particle size and the concentration of the polymer in the polymer dispersion.

14. The method of any preceding embodiment, wherein the droplets are dried prior to contacting the surface of the razor blade to a residual liquid content which is low enough so that the dried droplet matter is not mobile and/or not coalescing after contacting the surface of the razor blade edge.

15. The method of embodiment 14, wherein the droplets are dried prior to contacting the surface of the razor blade to a residual liquid content of less than 30 wt.-%, more specifically less than 20 wt.-%, even more specifically less than 10 wt.-%, yet more specifically less than 5 wt.-%, and in particular within the range of 0 to 3 wt.-%.

16. The method of any preceding embodiment, wherein the method is performed in a spray chamber.

17. The method of embodiment 16, wherein the spray chamber is operated at ambient pressure or at a partial vacuum, more specifically to an absolute pressure below 500 mbar, and in particular at an absolute pressure value below 100 mbar; and in particular at ambient pressure.

18. The method of embodiment 16 or embodiment 17, wherein the spray chamber is operated at a temperature ranging from 0 to 300° C., specifically from 5 to 100° C., and in particular from 10 to 50° C.

19. The method of any preceding embodiment, wherein the polymer dispersion is dispensed from a capillary nozzle having a diameter below 1 mm, more specifically below 500 μm, and in particular below 100 μm.

20. A system for coating a razor blade with a polymer, the razor blade terminating in an edge portion, wherein the edge portion has a continuously tapering geometry with two razor blade sides converging towards a razor blade edge,
wherein the system comprises a spray chamber for coating the razor blade; a container for receiving a polymer dispersion comprising a polymer in a liquid; a heater for heating the razor blade; and a controller for operating the system;
wherein the spray chamber is equipped with an electrically conductive capillary nozzle which is in fluid communication with the container for receiving the polymer dispersion, means for generating an electric field between capillary nozzle and the razor blade, and means for moving the capillary nozzle while moving the nozzle relative to the razor blade along the razor blade edge;
wherein the controller is configured to execute steps b. to g. of any one of embodiments 1 to 19.

21. A razor blade, the razor blade terminating in an edge portion, wherein the edge portion has a continuously tapering geometry with two razor blade sides converging towards a razor blade edge;

wherein one or both razor blade sides are provided with a coating comprising a polymer, wherein said coating forms a continuous stripe along the edge of the razor blade and wherein the continuous stripe is less than 25 μm, more specifically less than 20 μm, and in particular less than 15 μm, in width.

22. The razor blade according to embodiment 21, wherein the polymer has a melting point within the range of 100 to 500° C., more specifically in the range of 250 to 450° C., and in particular in the range of 300 to 400° C.

23. The razor blade according to embodiment 21 or 22, wherein the polymer is present on the blade in an amount of 0.1 to 20 μg, more particular from 0.5 to 10 μg, and in particular from 1 to 4 μg.

24. The razor blade according to embodiment 21 to embodiment 23, wherein the polymer is a fluorine-containing polymer, more specifically a polytetrafluoroethylene (PTFE) and in particular a polytetrafluoroethylene with a weight-average molecular weight of within the range of 2,000 g/mol to 120,000 g/mol, more specifically in the range of 10,000 g/mol to 80,000 g/mol, and in particular in the range of 20,000 g/mol to 60,000 g/mol.

25. The razor blade according to any one of embodiments 21 to 24, wherein the continuous stripe along the edge of the razor blade has a coating thickness within the range of 10 nm to 500 nm, more specifically 15 nm to 300 nm, and in particular 20 nm to 200 nm.

26. The razor blade according to any one of embodiments 21 to 25, wherein the razor blade's edge portion has a cross-section having a substantially symmetrical tapering geometry terminating in the razor blade edge, wherein the cross-section has a central longitudinal axis originating from the razor blade edge, and wherein the razor blade's edge portion has a thickness of between about 1.5 μm and about 2.4 μm measured at a distance of about 5 μm along the central longitudinal axis from the blade edge.

27. The razor blade according to any one of embodiments 21 to 26, wherein the razor blade is for a hand-held razor.

28. A razor blade preparable by the method of any one of embodiments 1 to 20.

29. A cartridge comprising a plurality of razor blades, wherein at least one of the razor blades is according to any of the preceding embodiments 21 to 27.

1. A method for coating a razor blade with a polymer,
the razor blade terminating in an edge portion, wherein the edge portion has a continuously tapering geometry with two razor blade sides converging towards a razor blade edge;
the method comprising the steps of:
a. providing a polymer in a liquid so as to obtain a polymer dispersion;
b. moving the polymer dispersion through an electrically conductive capillary nozzle;
c. creating an electric field between the capillary nozzle and the razor blade;
d. dispensing the polymer dispersion through the capillary nozzle while moving the nozzle relative to the razor blade along the razor blade edge;
e. atomizing the polymer dispersion into droplets and moving the droplets within the electric field towards the razor blade edge;
f. drying at least some of the droplets to particles comprising the polymer prior to contacting the surface of the razor blade edge; and
g. heating the razor blade at a temperature above the melting point of the polymer particles to form a polymer coating.

2. The method of claim 1, wherein the polymer dispersion comprises nanoparticles having a mean hydrodynamic diameter below 1000 nm, wherein the hydrodynamic diameter is measured by dynamic light scattering.

3. The method of claim 1, wherein the polymer dispersion comprises nanoparticles having a mean hydrodynamic diameter below 500 nm, wherein the hydrodynamic diameter is measured by dynamic light scattering.

4. The method of claim 1, wherein a polymer concentration in the polymer dispersion is greater than 5 wt.-% and less than 50 wt.-%, based on a total weight of the polymer dispersion.

5. The method of claim 1, wherein a polymer concentration in the polymer dispersion is greater than 5 wt.-% and less than 35 wt.-%, based on a total weight of the polymer dispersion.

6. The method of claim 1, wherein the polymer has a melting point within the range of 100° C. to 500° C.

7. The method of claim 1, wherein the polymer is a fluorine-containing polymer.

8. The method of claim 1 wherein the polymer is a polytetrafluoroethylene (PTFE).

9. The method of claim 1, wherein the dispensed polymer dispersion is atomized into droplets having a size in the range of 100 nm to 8 μm.

10. The method of claim 1, wherein the dispensed polymer dispersion is atomized into droplets by selecting and/or controlling one or more of: the electric field strength, the diameter of the capillary nozzle, the temperature of the dispersion, the ambient temperature, the ambient pressure and the surface tension of the polymer dispersion.

11. The method of claim 1, wherein the time of flight of the droplets prior to contacting the surface of the razor blade is adjusted to allow at least some of the droplets to dry prior to contacting the surface of the razor blade.

12. The method of claim 1, wherein at least some of the droplets are dried to particles comprising the polymer prior to contacting the surface of the razor blade edge by selecting and/or controlling one or more of: the electric field strength, the temperature of the dispersion, the ambient temperature, the ambient pressure, the boiling point and/or vapor pressure of the liquid, the gas flow encountered by the droplets in their flight path, the distance between the electrically conductive nozzle and the razor blade, the rate of atomization into the droplets, the size of the atomized droplets, and the particle size and the concentration of the polymer in the polymer dispersion.

13. The method of claim 1, wherein the droplets are dried prior to contacting the surface of the razor blade to a residual liquid content which is low enough so that the dried droplet matter is not mobile and/or not coalescing after contacting the surface of the razor blade edge.

14. A razor blade, the razor blade terminating in an edge portion, wherein the edge portion has a continuously tapering geometry with two razor blade sides converging towards a razor blade edge;
wherein one or both razor blade sides are provided with a coating comprising a polymer, wherein said coating forms a continuous stripe along the edge of the razor blade and wherein the continuous stripe is less than 25 μm in width.

15. The razor blade of claim 14 wherein the continuous stripe is less than 20 μm in width.

16. The razor blade according to claim 14, wherein the polymer is a fluorine-containing polymer.

17. The razor blade according to claim 14, wherein the polymer is a polytetrafluoroethylene (PTFE).

18. The razor blade according to claim 14, wherein the continuous stripe along the edge of the razor blade has a coating thickness within the range of 10 nm to 500 nm.

19. The razor blade according to claim 14, wherein the continuous stripe along the edge of the razor blade has a coating thickness within the range of 15 nm to 300 nm.

20. A razor blade preparable by the method of claim 1.
